(19) United States
(12) Patent Application Publication
(10) Pub. No.: US 2004/0218721 A1
(43) Pub. Date: Nov. 4, 2004

(54) Miniature x-ray apparatus

(76) Inventors: Victor I. Chornenky, Minnetonka, MN (US); Vance E. Swanson, Santa Rosa, CA (US); Zirao Zheng, Santa Rosa, CA (US); Eunsung Park, Minneapolis, MN (US); Jason Kolden, Windsor, CA (US)

Correspondence Address: MEDTRONIC VASCULAR, INC., IP LEGAL DEPARTMENT, 3576 UNOCAL PLACE, SANTA ROSA, CA, 95403, US

(21) Appl. No.: 10/427,350

(22) Filed: Apr. 30, 2003

(51) Int. Cl. G21G 4/00; H01J 35/00

(52) U.S. Cl. 378/119

(57) ABSTRACT

An apparatus is provided for delivering x-ray radiation to interior surface tissue of a body cavity. The apparatus comprises a flexible introducer guide having a distal end and a proximal end, the distal end for insertion into the body cavity. An inflatable balloon is mounted proximate the distal end of the flexible introducer guide and is selectively inflated to conform the balloon to the body cavity. A flexible x-ray catheter is configured for movement within the introducer guide, and an x-ray emitter is coupled to the distal end of the x-ray catheter for generating x-rays to irradiate the interior surface tissue. The x-ray emitter is also coupled to a source of high voltage. A controller is coupled to the x-ray emitter to control the area of irradiation and the dosage of radiation generated by the emitter.

### TECHNICAL FIELD

This invention relates generally to a miniature x-ray apparatus, and more particularly to an implantable x-ray apparatus for performing intraoperative radiation treatment (IORT) of marginal tissue surrounding a surgically removed tumor.

### BACKGROUND OF THE INVENTION

The medical community is constantly striving for less invasive techniques to treat cancer patients; e.g. those suffering from breast cancer, prostate cancer, colon cancer, or the like. For example, in the not too distant past, treatment for breast cancer generally required a mastectomy which is a surgical procedure involving removal of the entire breast. More recently, women have been afforded an option which is referred to as a lumpectomy; i.e. a less drastic form of surgery which involves removing only the tumor and a portion of the surrounding tissue. In fact, clinical studies have generally shown that a lumpectomy combined with postoperative radiation therapy is as effective as a mastectomy with respect to patient survival rate and probability of remaining cancer free. Since a lumpectomy preserves healthy breast tissue, it is often referred to as breast conservation surgery. For these reasons, a lumpectomy followed by breast radiation is now the preferred treatment for women with primary breast cancer; i.e. 80% of women who presently have breast cancer have tumors treatable by lumpectomy. Such treatment is especially appropriate and generally successful in breast cancer patients having small, non-invasive tumors.

External bream radiation therapy (EBRT) is one irradiation technique that may be utilized after a lumpectomy. An external ionizing radiation beam is directed onto the target tissue (tumor) from multiple angles. These overlapping or intersecting beams provide for the delivery of radiation to the target tissue while only slightly irradiating the healthy tissue between the beam source and the target tissue. However, in order to accommodate movements of the target volume during treatment, a larger beam width is required which limits precision and the maximum radiation dose that can be delivered by the EBRT apparatus to the target tissue or tumor bed.

EBRT is often used in combination with a temporarily implanted brachytherapy source. Brachytherapy is a cancer treatment which involves the placement of radioactive seeds or sources in the tumor itself thus delivering a high dose of radiation (i.e. higher than the dose associated with EBRT) to the tumor. By combining EBRT and brachytherapy, a patient is treated in a wider area but with a lower dosage of radiation thus treating the tumor and any cancer cells in the generally surrounding tissue while at the same time providing a higher dosage of radiation which is localized at the tumor itself and the immediately surrounding tissue.

The most frequently used brachytherapy radiation source, Iridium-192, is used in high-dose-rate (HDR) afterloaders of the type produced by, for example, Nucletron, Inc. in Columbia, Md. In an afterloader, a single, tiny (e.g. 1 mm×3 mm), highly radioactive source of Iridium-192 is laser welded to the end of a thin, flexible, stainless steel cable. The afterloader directs the cable through catheters or applicators placed in the patient by a brachytherapy physician. The radiation source travels through each catheter in, for example, 5 millimeter steps referred to as dwell positions. The radiation distribution and the dose are determined by the location of the dwell positions and the length of dwell. After each treatment, the source is retracted back into the afterloader. This ability to control the radiation doses permits prescribed doses to be delivered to the tumor while minimizing irradiation of nearby normal tissue, and since Iridium-192 is highly radioactive, the length of each treatment is in the order of minutes rather than days. While a program of brachytherapy treatment may only require from three to ten treatments depending on the type of cancer being treated, the technique has certain drawbacks. For example, not only is it very costly, but operating rooms must be provided with an especially high degree of radiation protection.

One known apparatus that employs an implantable device for radiation treatment is shown and described in U.S. Pat. No. 6,022,308 entitled “Tumor Treatment”. In this case, radiation treatment is provided to tissue surrounding a cavity left after surgical removal of a brain tumor. This apparatus includes and inflatable balloon for implantation into the cavity and means for the transdermal delivery of a radioactive fluid into the balloon. The fluid may contain radioisotopes 90-Yttrium, 125 or 131-Iodine, or 32-Phosphorus. The radioactive fluid is injected into the balloon after the completion of surgery and remains inside the cavity until the radiation treatment is completed. Unfortunately, this system employs radioactive isotopes exposing medical professionals to radiation.

Another known apparatus is shown and described in U.S. Pat. No. 5,621,780 entitled “X-Ray Apparatus for Applying a Predetermined Flux to an Interior Surface of a Body Cavity” and describes an x-ray device for the irradiation of body cavities. The device comprises a housing, an elongated tubular probe, a target assembly in the distal end of the probe, and a balloon affixed to the distal end of the probe. After the probe has been inserted into a body cavity, the balloon may be inflated to stretch the cavity into a desire shape. Positioning the probe tip inside the inflated balloon enables delivery of radiation to the surface defining the body cavity. Unfortunately, this system does not deliver a uniform dose of radiation to non-spherical cavities without tailoring the radiation pattern of the source. This is a difficult and time-consuming procedure. Furthermore, since the probe is not flexible, relative movement between the source and the patient is still a problem as it is in the case of external beam radiation therapy.

In view of the foregoing, it should be appreciated that it would be desirable to provide an improved method and apparatus for delivering a uniform radiation dose to a predetermined isodose surface beyond a cavity left by the surgical removal of a tumor or other natural body cavity.

It should further be appreciated that it would be desirable to provide a high-dose-rate (HDR) source of ionizing radiation suitable for intraoperative radiation therapy that can easily be utilized in a standard operating room without the need for retrofitting in order to provide the required radiation protection from gamma HDR sources. The radiation source should be compatible with different applicators currently used in conjunction with afterloaders or in a variety of other therapeutic environments encountered in an oncology practice.

It should still further be appreciated that it would be desirable to provide a low-cost non-radioactive source for intraoperative radiation therapy. For example, an x-ray source does not include radioactive materials and is therefore not subject to the regulations imposed by the Nuclear Regulatory Commission. Thus, x-ray sources are more accessible and less expensive. As a result, x-ray HDR brachytherapy sources may be used in hospitals that are not licensed to use radioactive materials and/or those that are not equipped with bunker-type protection from radioactivity.

### SUMMARY OF THE INVENTION

According to a first aspect of the invention, there is provided an x-ray apparatus for delivering x-ray radiation to interior surface tissue of a body cavity. The apparatus comprises a flexible introducer guide having a distal end and a proximal end, the distal end being configured for insertion into the body cavity. An inflatable balloon is mounted proximate the distal end of the flexible introducer guide and is selectively inflated to conform the balloon to the body cavity. A flexible x-ray catheter is configured for movement within the introducer guide, and an x-ray emitter is coupled to the distal end of the x-ray catheter for generating x-rays to irradiate the interior surface tissue. The x-ray emitter is coupled to a source of high voltage, and a controller is coupled to the x-ray catheter to control the area of irradiation and the dosage of radiation generated by the emitter.

According to a further aspect of the invention, there is provided a method for delivering x-ray radiation to the interior surface tissue of a body cavity which comprises inserting a flexible introducer guide into the body cavity, inflating a balloon mounted at the distal end of the introducer guide-so as to conform the balloon with the body cavity, inserting a flexible x-ray catheter having an x-ray emitter on the distal end thereof into and along the introducer guide until the emitter is positioned proximate the body cavity, applying a high voltage to the emitter to generate x-ray radiation and irradiate the interior surface tissue of the body cavity, and controlling the area of irradiation and the delivered dosage.

### BRIEF DESCRIPTION OF THE DRAWINGS

The following drawings are illustrative of particular embodiments of the invention and therefore do not limit the scope of the invention, but are presented to assist in providing a proper understanding of the invention. The drawings are not to scale (unless so stated) and are intended for use in conjunction with the explanations in the following detailed description. The present invention will hereinafter be described in conjunction with the appended drawings, wherein like reference numerals denote like elements, and:

FIG. 1 is a diagrammatic illustration, partially in cross-section, of a miniature high-dose-rate x-ray apparatus for performing intraoperative radiation therapy in accordance with a first embodiment of the present invention;

FIG. 2 is a cross-sectional view of a miniature x-ray emitter which generates a unidirectional radial radiation beam and has a relatively thick target for use in conjunction with the apparatus shown in FIG. 1;

FIG. 3 is a cross-sectional view of the x-ray emitter shown in FIG. 2 taken along line 3-3;

FIG. 4 is a cross-sectional view of a miniature x-ray emitter which generates a doughnut-like radiation pattern and has a relatively thick target for use in conjunction with the apparatus shown in FIG. 1;

FIG. 5 is a cross-sectional view of a miniature x-ray emitter which generates a doughnut-like radiation pattern and has a relatively thin target for use in conjunction with the apparatus shown in FIG. 1;

FIG. 6 is a diagrammatic illustration of a miniature high-dose-rate brachytherapy device utilized with a Harrison-Anderson-Mick (HAM) applicator for intraoperative radiation therapy in accordance with another embodiment of the present invention;

FIG. 7 is a graphical illustration of isodose curves near a tumor bed resulting from multiple passes of an x-ray emitter of the type shown in FIGS. 2, 4, and 5; and

FIG. 8 is a diagrammatic illustration of a miniature high-dose-rate x-ray apparatus including a perineal multi-needle applicator for the radiation treatment of prostate cancer in accordance with yet another embodiment of the present invention.

### DETAILED DESCRIPTION OF THE EXEMPLARY EMBODIMENT

The following description is exemplary in nature and is not intended to limit the scope, applicability, or configuration of the invention in any way. Rather, the following description provides a convenient illustration for implementing exemplary embodiments of the invention. Various changes to the described embodiments may be made in the function and arrangement of the elements described herein without departing from the scope of the invention.

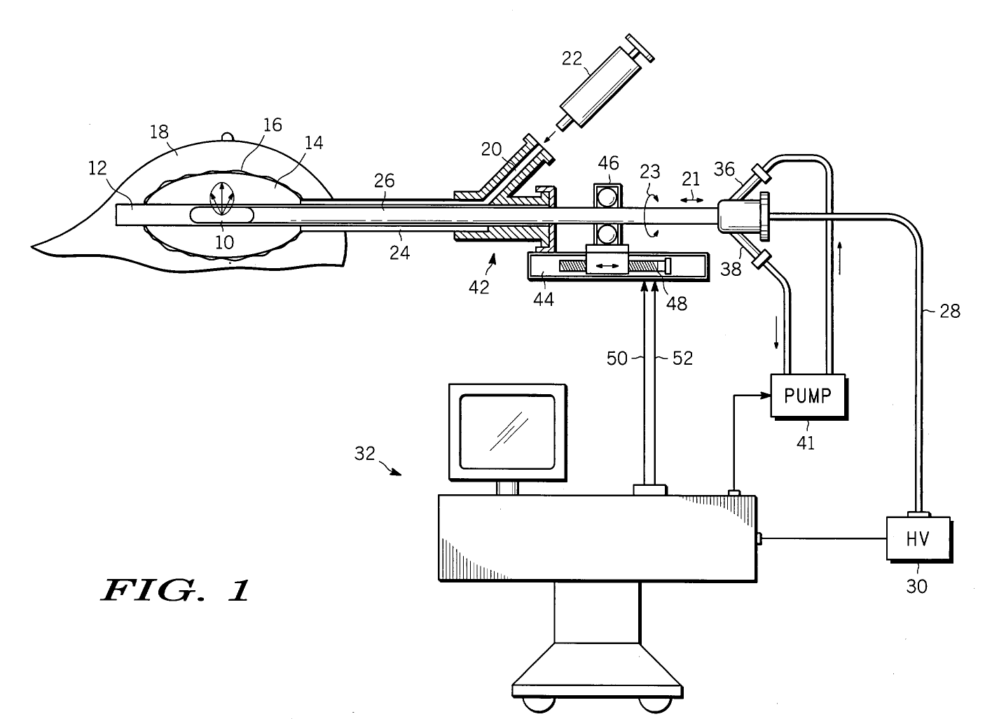

FIG. 1 is a diagrammatic illustration, partially shown in cross-section, of a miniature high-dose-rate x-ray apparatus for performing intraoperative radiation therapy on a breast cancer patient in accordance with the teachings of the present invention. As can be seen, an x-ray emitter 10 is positioned within a flexible introducer guide 12 having a balloon 14 secured thereon. Flexible introducer guide 12 may be made of a flexible plastic, metal, or other material suitable for the intended purpose. Balloon 14 may be made from soft compliant polymers, for example latex, so as to permit balloon 14 to conform to a cavity 16 when inflated as will be described below. It should be appreciated that although it has been stated above that balloon 14 may consist of soft compliant polymer materials, other materials which possess the characteristics and properties suitable for the intended purpose may be employed.

Introducer guide 12 is inserted into a patient's breast 18 through small surgical incisions, and balloon 14, now in a collapsed or deflated configuration and closely surrounding introducer guide 12, is positioned within surgical cavity 16 which was left in breast 18 as a result of the surgical removal of a malignant tumor. Balloon 14 is in fluid communication with catheter port 20 and syringe 22 by means of a channel 24. Thus, upon proper positioning of the collapsed balloon 14 proximate cavity 16, balloon 14 may be inflated by injecting fluid into the balloon via syringe 22, catheter port 20 and communication channel 24 so as to prepare cavity 16 for irradiation.

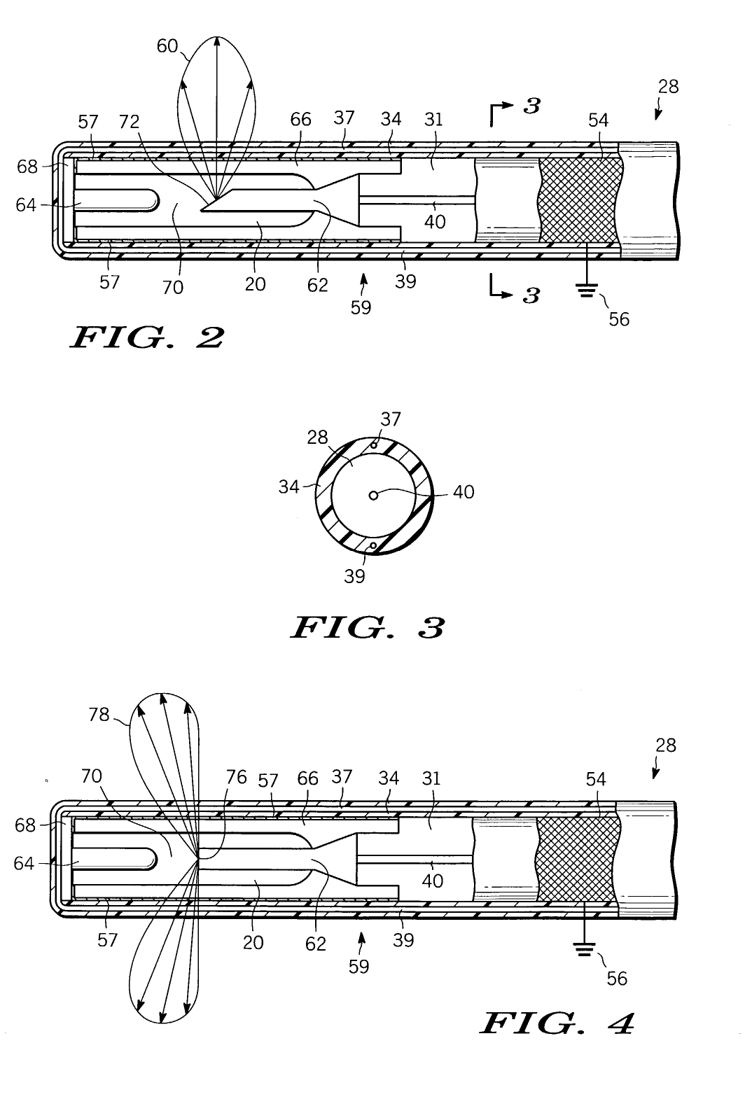

X-ray catheter 26 includes x-ray emitter 10 which is coupled by means of, for example, a high voltage coaxial cable 28 (having an outer braid 54, an insulating layer 31, and a center conductor 40 shown in FIG. 2) to a high voltage source 30 (e.g. 30-50 kV and capable for delivering several watts of power). High voltage power source 30 is in turn coupled to and controlled by a computerized controller 32 which controls, among other things, the area of irradiation and the delivered dosage.

Referring also to FIG. 2, a plastic or metal catheter sheath 34 is positioned over coaxial cable 28 and is provided with first and second relatively small diameter channels 37 and 39 respectively. Port 36 is a catheter input port, and port 38 is a catheter output port. A pump 41 controlled by controller 32 pumps coolant into input port 36. The coolant then flows through channel 37 in catheter sheath 34, around x-ray emitter assembly 20, through channel 39, and is retrieved at output port 38. This flow of coolant around emitter 10 serves to cool the emitter during operation. FIG. 3 is a cross-sectional view of the emitter assembly shown in FIG. 2 and more clearly illustrates central conductor 40, insulating layer 31, catheter sheath 34, input channel 37, and output channel 39.

Referring again to FIG. 1, the proximal end 42 of introducer guide 12 is secured to a pull back device 44 which is configured to move x-ray catheter 26 inside introducer guide 12 both longitudinally and rotationally as is indicated by arrows 21 and 23 respectively to provide a required irradiation pattern to the marginal tissue surrounding the excised tumor. Thus, pull back device 44 includes a rotational stage 46 that produces rotation of x-ray catheter 26 about its own axis, and includes a translational stage 48 that provides for longitudinal movement of x-ray catheter 26. Both rotational and longitudinal movement of x-ray catheter 26 by means of rotational stage 46 and translational stage 48 occurs in response to signals from computerized controller 32 as is indicated by connections 50 and 52.

FIG. 2 is a cross-sectional view of a miniature x-ray emitter in accordance with the teachings of the present invention which generates a single sided or unidirectional irradiation pattern for use in conjunction with the inventive miniature high-dose-rate x-ray apparatus shown in FIG. 1. Referring to FIG. 2, there is shown coaxial cable 28 having a center conductor 40 and an outer braid or conductor 54 which may be coupled to a common ground 56 with controller 32 (FIG. 1). Coaxial cable 28 is coupled to and cooperates with x-ray emitter 20 which radiates x-ray energy as a single sided beam 60. Emitter 20 is connected to the distal end 59 of coaxial cable 28 and comprises an anode 62 and a cathode 64 mounted in a miniature vacuum tube formed by shell (e.g. quartz) 66 and end cap 68 (made of a suitable metal such as molybdenum, tungsten, nickel, etc.). Braid 54 is also coupled to a metallic coating 57 (e.g. titanium-silver) disposed on shell 66.

As alluded to previously, center conductor 40 of coaxial cable 28 is coupled to a high voltage (25-50 kV), and braid 54 of coaxial cable 28 is coupled to a common ground with controller 32 (FIG. 1) as is represented at 56. Center conductor 40 is coupled to anode 62. Thus, the high voltage to which center conductor 40 is coupled is applied to the miniature vacuum tube creating a high electric field between cathode 64 and anode 62. This high electric field causes electrons to be emitted from the surface of cathode 64 into vacuum gap 70 between cathode 64 and anode 62 where the electrons are accelerated by the electric field and strike anode 62 causing x-ray energy to be radiated. As can be seen, anode surface 72 is cut at an angle of for example, 10°-60° relative to the longitudinal axis of the emitter. As a result, x-ray radiation which would otherwise be emitted in a downward direction is absorbed by anode 62 thus producing only an upwardly directed beam 60. Such an x-ray catheter having only a one sided emission pattern requires rotation during the radiation of the tissues surrounding a surgically removed tumor.

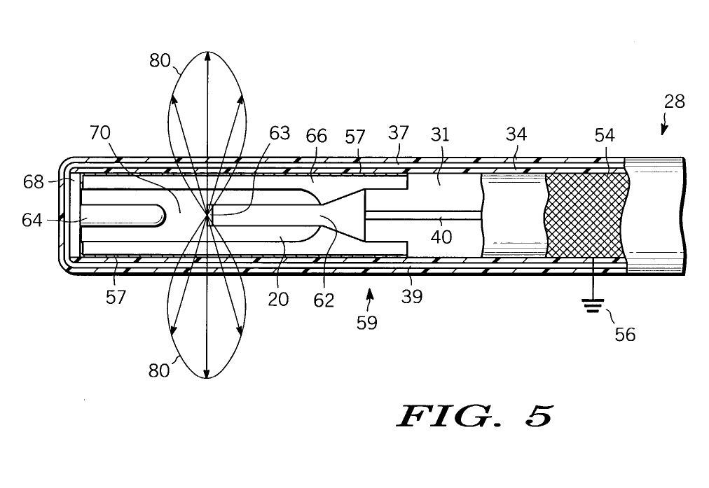

FIG. 4 is a cross-sectional view of another miniature x-ray emitter in accordance with the teachings of the present invention. This x-ray emitter is virtually identical to that shown in FIG. 2 with the exception that the front surface 76 of anode 62 lies in a plane which is normal to the longitudinal axis of the emitter. As electrons strike surface 76 of anode 62, a radiation pattern which is uniform in all azimuthal directions is produced as is shown at 78.

FIG. 5 is a cross-sectional view of a miniature x-ray emitter exhibiting a doughnut-like radiation pattern and employing a relatively thin target. Such an emitter is described in copending U.S. Patent Application Serial No. P963 filed on even date herewith and entitled Miniature X-ray Emitter. Anode 62 is made of a material that is transparent to x-ray radiation (e.g. beryllium), and only a thin layer 63 on the front surface of anode 62 is comprised of a heavy metal such as gold or tungsten. This results in an x-ray emitter which is significantly more efficient in that the overall emission of x-rays is several times higher than in the case of a thick anode of the type shown in connection with the emitter of FIG. 4. This is due to the fact that most of the x-ray energy emitted by decelerating electrons is emitted in the forward direction and, in the case of a thick anode, is lost due to bulk absorption in the anode material. The result is a more efficient doughnut shaped radiation pattern 80 having a uniform azimuthal radiation pattern.

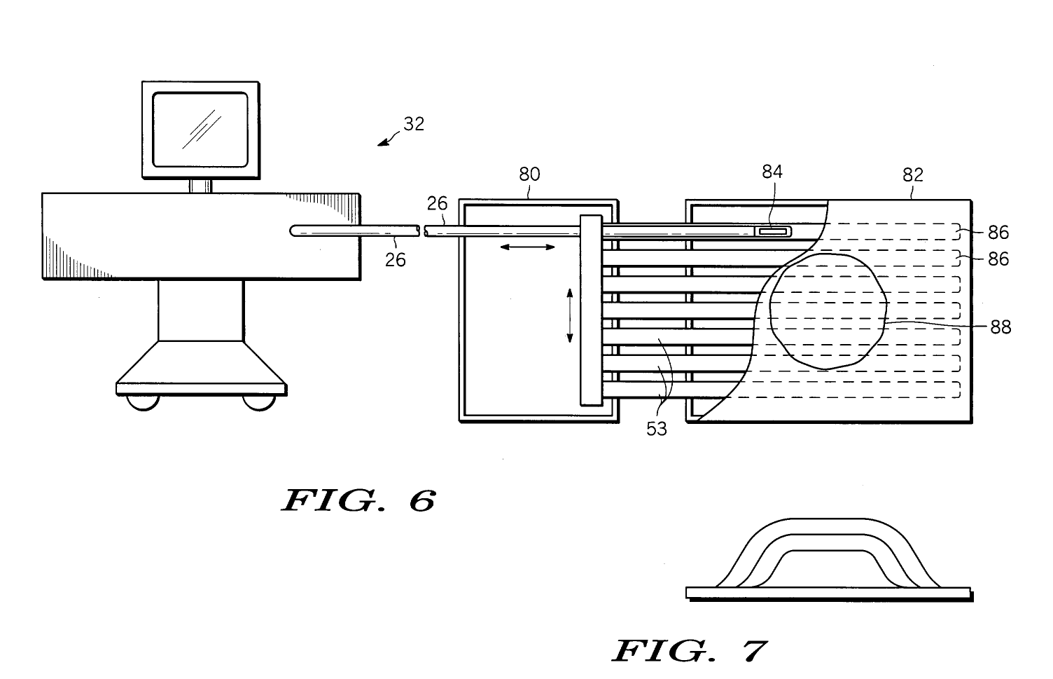

FIG. 6 is a diagrammatic illustration of a miniature high-dose-rate brachytherapy device utilized in conjunction with a Harrison-Anderson-Mick (HAM) applicator of the type which is used for a variety of intraoperative radiation treatments, particularly primary unresectable and locally advanced recurrent colorectal cancers. The advantage of such a device is the ability to move normal organs away from the tumor bed and deliver a high dose of radiation to the area at risk (see L. Harrison et al., International Journal of Radiation Oncology Biol, volume 24, number 2, pp. 325-330, 1998). Typically, an electron beam from a linear accelerator is utilized for intraoperative radiation therapy. However, a dedicated linear accelerator in an operating room may be too expensive for most medical centers, and transporting an anesthetized patient from the operating room to the radiation oncology department is not an optimal solution. Furthermore, there are a number of anatomical situations wherein the electron cones do not conform well to the target area rendering it virtually impossible to provide appropriate irradiation. The advantage of HDR brachytherapy and miniature x-ray therapy in particular is that it can be delivered to virtually any area of the body and provide a high conformity irradiation pattern to the tumor bed.

The apparatus shown in FIG. 6 comprises a controller 32 of the type previously described, a pull-back system 80, and a HAM applicator 82. A miniature x-ray emitter 84 of the type described hereinabove in connection with FIGS. 2, 4, and 5, is coupled at the distal end of catheter 26 (again of the type previously described). HAM applicator 82 may be manufactured of a soft silicon material and contains a plurality of channels 86 each of which is adapted to receive and pass emitter 84 along its length. Applicator 82 is attached (e.g. sewn) to tumor bed 88. Emitter 84 is turned on and off under the control of controller 32 as it travels through channels 86 proximate tumor bed 88 in accordance with a preprogrammed treatment plan. Emitter 84 travels through each channel and from channel to channel under the control of pull back system 80 which is likewise controlled by controller 32. FIG. 7 graphically shows isodose curves near the tumor bed resulting from multiple passes of emitter 84 over tumor bed 88.

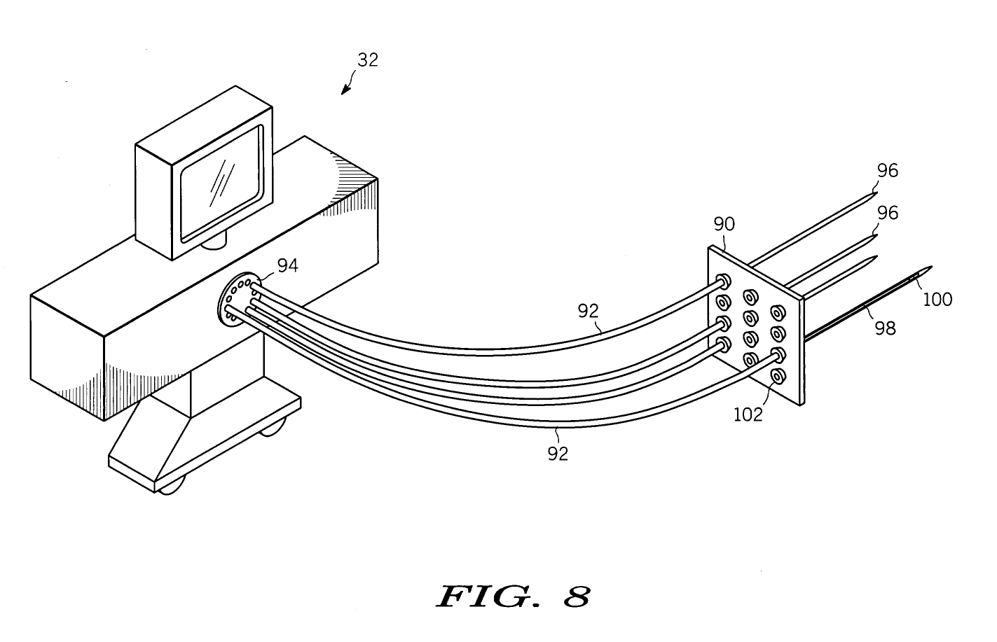

FIG. 8 is a diagrammatic illustration of a miniature high-dose-rate x-ray apparatus including a perineal multi-needle applicator for the radiation treatment of prostate cancer in accordance with a further embodiment of the present invention. In the past decade, seed implantation brachytherapy has achieved a very high curability and survival rate for prostate cancer. The quality of life for the patients surviving prostate cancer, however, is still a concern. The high radiation doses delivered to the urethra cause fibrosis and may lead to incontinence that becomes more and more severe as time passes by. Excessive radiation of the anterior rectal wall leads to deterioration of rectal function. These side effects could be avoided if better conformity of the radiation pattern to the prostate were achieved. The miniature x-ray brachytherapy technique described above including the rotating beam pattern and controlled depth of penetration into tissue permits better conformity and consequently less radiation injury to healthy tissue to be achieved.

Referring to FIG. 8, there is again shown a controller 32 which is coupled to a perineal template 90 by means of a plurality of transport tubes 92 coupled between template 90 and flange 94 on controller 32. A plurality of needles 96 extends through perineal template 90 and are introduced into the body of the prostrate (not shown). The proximal ends of needles 96 are adapted to receive an x-ray catheter 98 of the type described hereinabove. The x-ray catheter 98 is equipped with an emitter 100 at its tip, the emitter being the type shown in connections with FIGS. 2, 4 and 5 above. Catheter 98 and emitter 100 are sequentially introduced into needles 96 under the control of controller 32. That is, the proximal ends 102 of needles 96 are adapted to receive x-ray catheter 98. As x-ray catheter 98 travels along a needle, it consecutively dwells at predetermined positions for predetermined periods of time to provide a prescribed distribution of radiation to the prostate. Of course, a plurality of catheters 98 and emitters 100 may be employed.

X-ray emitters 100 used for prostate irradiation may have an azimuthally uniform radiation pattern or a radiation pattern directed predominately to one side. The former may be used in the central needles of the template for providing relatively uniform irradiation of the central part of the prostate. The latter may be used at the margins of the radiation field interfacing with healthy tissue. In this case, preprogrammed rotation of the emitter would be employed in addition to the translation motion along the length of the needles to provide better conformity of the radiation pattern to the shape of the prostate itself and to decrease the dose delivered to the healthy tissue of the urethra and anterior rectal wall.

In summary, there has been provided an apparatus for providing intraoperative radiation therapy which includes a miniature x-ray emitter and an inflatable balloon adapted for placement in a cavity left as a result of the surgical removal of a malignant tumor. The balloon is secured on a flexible sheath which has a channel fluidly communicating with a syringe at the distal end thereof outside the patient's body so as to provide for inflation of the balloon during radiation treatment. The x-ray emitter is coupled to a high voltage coaxial cable and is placed inside the sheath. In one embodiment, the emitter emits ionizing radiation in predominately one radial direction and is adapted to slide along and rotate about the sheath's axis. A computerized controller provides digital control of the axial and rotational motions of the emitter to provide for the delivery of a prescribed radiation dose to a predetermined depth into the tissue surrounding the surgical cavity. This embodiment of the apparatus is intended for highly asymmetric tumors. In another embodiment, the emitter is constructed to emit radiation symmetrically in all radial directions. This version is intended predominately for axially symmetric tumors, and a symmetric irradiation pattern of the tissue around the former malignant tumor is produced. The balloon may be made of a soft compliant polymer such as latex to conform to the cavity left by the surgery. The coaxial cable is coupled at its proximal end to a high voltage source (e.g. 30-50 kV) capable of delivering several watts of electric power and is covered with a plastic layer (or thick walled metal tube) having two small longitudinal channels therethrough for conducting a cooling fluid to a pocket around the emitter. In this manner, heat produced by the process of x-ray production is carried away from the emitter. Embodiments are presented illustrating the use of the inventive miniature x-ray apparatus in conjunction with a Harrison-Anderson-Mick applicator and a perineal template.

Thus, there has been provided an improved method and apparatus for delivering a uniform radiation dose to a predetermined isodose surface beyond a cavity left by the surgical removal of a tumor. There has also been provided a high-dose-rate source of ionizing radiation suitable for intraoperative radiation therapy that can be easily utilized in a standard operating room without the need for retrofitting in order to provide the required radiation protection from gamma HDR sources. The radiation source is compatible with different applicators currently being used in conjunction with HDR afterloaders and is also capable of being used in a variety of other therapeutic environments encountered in the practice of oncology. The source is low cost and non-radioactive and therefore is not subject to the regulations imposed by the Nuclear Regulatory Commission. X-ray sources are more accessible, less expensive, and x-ray HDR brachytherapy sources may be utilized in hospitals that are not licensed to use radioactive materials.

In the foregoing specification, the invention has been described with reference to specific embodiments. However, it should be appreciated that various modifications and changes can be made without departing from the scope of the invention as set forth in the appended claims. Accordingly, the specification and figures should be regarded as illustrative rather than restrictive, and all such modifications are intended to be included within the scope of the present invention.

What is claimed is:

1. An x-ray apparatus for delivering x-ray radiation to interior surface tissue of a body cavity, comprising:
a flexible introducer guide having a distal end and a proximal end, said distal end for insertion into said body cavity;
an inflatable balloon mounted proximate the distal end of said flexible introducer guide;
first means for selectively inflating said balloon to conform to said body cavity;
a flexible x-ray catheter configured for movement within said introducer guide, said x-ray catheter having a distal end and a proximal end;
an x-ray emitter coupled to the distal end of said x-ray catheter for generating x-rays to irradiate said interior surface tissue, said x-ray emitter configured for coupling to a high voltage source; and
a controller coupled to said x-ray catheter and adapted for coupling to the high voltage source for controlling the area of irradiation and the dosage of radiation.

2. An x-ray apparatus according to claim 1 wherein said x-ray emitter is coupled to the high voltage source by a flexible cable having first and second conductors, said first conductor coupled to said high voltage source and insulated from said second conductor.

3. An x-ray apparatus according to claim 2 wherein said x-ray emitter comprises;
a vacuum chamber;
a cathode positioned within said vacuum chamber; and
an anode positioned within said vacuum chamber and positioned to create a vacuum gap between said anode and said cathode, said anode coupled to said first conductor so as to create an electric field between said anode and said cathode causing electrons to be emitted from said cathode and strike a front region of said anode thereby causing x-rays to be emitted.

4. An x-ray apparatus according to claim 3 wherein said flexible cable is a coaxial cable having a center conductor and an outer conductor which is insulated from said center conductor.

5. An x-ray apparatus according to claim 3 wherein said front region is substantially perpendicular to the direction of flow of electrons from said cathode resulting in the generation of a doughnut shaped radiation pattern.

6. An x-ray apparatus according to claim 3 wherein said front region is oriented at an angle relative to the direction of flow of electrons from said cathode resulting in the generation of a substantially single sided radiation pattern.

7. An x-ray apparatus according to claim 6 wherein said angle is between 10 degrees and 60 degrees.

8. An x-ray apparatus according to claim 3 further comprising first means coupled to said controller and to said x-ray catheter for moving said x-ray catheter translationally within said introducer guide.

9. An x-ray apparatus according to claim 8 further comprising second means coupled to said controller and to said x-ray catheter for rotating said x-ray catheter within said introducer guide.

10. An x-ray apparatus according to claim 3 further comprising:
a channel in said x-ray catheter; and
cooling means for pumping a coolant through said channel to cool said emitter.

11. An x-ray apparatus according to claim 3 wherein said vacuum chamber comprises an insulating shell having an end cap at one end thereof.

12. An x-ray apparatus according to claim 11 wherein said insulating shell is Quartz.

13. An x-ray apparatus according to claim 3 wherein said anode is made of a heavy metal.

14. An x-ray apparatus according to claim 13 wherein said heavy metal is tungsten.

15. An x-ray apparatus according to claim 13 wherein said heavy metal is gold.

16. An x-ray apparatus according to claim 1 wherein said flexible introducer guide is plastic.

17. An x-ray apparatus according to claim 1 wherein said flexible introducer guide is a flexible metal.

18. An x-ray apparatus according to claim 1 wherein said balloon is made of a polymeric material.

19. A method for delivering x-ray radiation to interior surface tissue of a body cavity, comprising:
inserting a flexible introducer guide into said body cavity;
inflating a balloon mounted at the distal end of the introducer guide so as to conform the balloon with the body cavity;
inserting a flexible x-ray catheter having an x-ray emitter on the distal end thereof into and along the introducer guide until the emitter is positioned substantially proximate the body cavity;
applying a high voltage to the emitter to generate x-ray radiation to irradiate the interior surface tissue of the body cavity; and
controlling the area of irradiation and the dosage of radiation.

20. A method according to claim 19 further comprising generating a single sided radiation beam.

21. A method according to claim 19 further comprising generating a doughnut shaped radiation beam.

22. A method according to claim 21 further comprising selectively rotating the x-ray catheter within the introducer guide.

23. A method according to claim 21 further comprising selectively moving the x-ray catheter translationally within the introducer guide.

24. A method according to claim 21 further comprising selectively moving the x-ray catheter translationally and rotationally with the introducer guide.

25. A method according to claim 24 further comprising cooling the emitter.

26. A method according to claim 25 wherein the step of cooling comprises pumping a coolant through channels in the x-ray catheter.

27. An x-ray apparatus for delivering x-ray radiation to interior surface tissue of a body cavity, comprising:
a flexible introducer guide having a distal end and a proximal end, said distal end for insertion into said body cavity;
a flexible x-ray catheter configured for movement within said introducer guide, said x-ray catheter having a distal end and a proximal end; and
an x-ray emitter coupled to the distal end of said x-ray catheter for generating x-rays to irradiate said interior surface tissue, said x-ray emitter configured for coupling to a high voltage source.

28. An x-ray apparatus according to claim 27 further comprising a controller coupled to said x-ray catheter for controlling the area of irradiation and the delivered dosage.

29. An x-ray apparatus according to claim 27 further comprising:
an inflatable balloon mounted proximate the distal end of said flexible introducer guide; and
first means for selectively inflating said balloon.

30. An x-ray apparatus according to claim 28 wherein said x-ray emitter is coupled to the high voltage source by a flexible cable having first and second conductors, said first conductor coupled to said high voltage source and insulated from said second conductor.

31. An x-ray apparatus according to claim 30 wherein said x-ray emitter comprises;
a vacuum chamber;
a cathode positioned within said vacuum chamber; and
an anode positioned within said vacuum chamber and positioned to create a vacuum gap between said anode and said cathode, said anode coupled to said first conductor so as to create an electric field between said anode and said cathode causing electrons to be emitted from said cathode and strike a front region of said anode thereby causing x-rays to be emitted.

32. An x-ray apparatus according to claim 31 wherein said flexible cable is a coaxial cable having a center conductor and an outer conductor which is insulated from said center conductor.

33. An x-ray apparatus according to claim 31 wherein said front region is substantially perpendicular to the direction of flow of electrons from said cathode resulting in the generation of a doughnut shaped radiation pattern.

34. An x-ray apparatus according to claim 31 wherein said front region is oriented at an angle relative to the direction of flow of electrons from said cathode resulting in the generation of a substantially single sided radiation pattern.

35. An x-ray apparatus according to claim 31 further comprising first means coupled to said controller and to said x-ray catheter for moving said x-ray catheter translationally within said introducer guide.

36. An x-ray apparatus according to claim 35 further comprising second means coupled to said controller and to said x-ray catheter for rotating said x-ray catheter within said introducer guide.

37. An x-ray apparatus according to claim 35 further comprising:
a channel in said x-ray catheter; and
cooling means for pumping a coolant through said channel to cool said emitter.
